(19) United States
(12) Patent Application Publication
(10) Pub. No.: US 2015/0300998 A1
(43) Pub. Date: Oct. 22, 2015

(54) MICROCOLUMN FOR USE IN GAS CHROMATOGRAPHY

(71) Applicant: The Board of Trustees of the University of Illinois, Urbana, IL (US)

(72) Inventors: Kenneth S. Suslick, Champaign, IL (US); Jacqueline M. Rankin, Champaign, IL (US)

(21) Appl. No.: 14/477,060

(22) Filed: Sep. 4, 2014

Related U.S. Application Data
(60) Provisional application No. 61/874,543, filed on Sep. 6, 2013.

(51) Int. Cl. B01J 20/281; C08L 63/00; C08L 83/04; G01N 30/60

(52) U.S. Cl. CPC G01N 30/48; G01N 30/6095; C08L 63/00; C08L 83/04; G01N 2030/486

(57) ABSTRACT

A microcolumn for use in gas chromatography comprises a self-supporting polymer body that functions as a stationary phase and a structural support. The polymer body comprises an enclosed channel having a length L, height h and width w extending therethrough and one or more channel walls surrounding the enclosed channel. The one or more channel walls are integrally formed with the polymer body. The polymer body and the one or more channel walls may comprise a phase-separated polymer composition.

### RELATED APPLICATION

The present patent document claims the benefit of priority under 35 U.S.C. §119(e) to U.S. Provisional Patent Application Ser. No. 61/874,543, filed on Sep. 6, 2013, which is hereby incorporated by reference in its entirety.

### FEDERALLY SPONSORED RESEARCH OR DEVELOPMENT

This invention was made with government support under contract number Army N41756-12-C-4767 awarded by the Department of Defense and grant numbers CHE 11-52232 and DGE 11-44245 awarded by the National Science Foundation. The government has certain rights in the invention.

### TECHNICAL FIELD

The present disclosure is directed generally to gas separation technology and more particularly to polymeric microcolumns for gas chromatography.

### BACKGROUND

Gas chromatography (GC) is a well-known analytical technique for separating and analyzing complex mixtures of volatile or semivolatile compounds. However, conventional GC systems tend to be bulky with high power consumption and long analysis times. These shortcomings have limited GC use predominantly to laboratory environments and have made in situ analysis of field or environmental samples difficult. Immediate results are particularly important in situations where chemicals that are dangerous to life and health may be present (e.g., in chemical workplace monitoring, industrial accidents, and military settings). Therefore, it would be advantageous to have a portable instrument capable of real-time gas analysis that can be operated in the field by minimally trained first responders. Due to the potential widespread applicability of such technology, there is growing interest in the development of portable GC systems that are not only small and low-power, but also low-cost and easily mass produced. Toward this end, the development of extremely compact GC systems, often called micro GC (μGC), has been pursued by national laboratories, universities, and instrumentation companies for applications in biomedicine, environmental sciences, and national defense.

In the past decade, there has been substantial progress made in microcolumn separation efficiency. However, the microcolumn fabrication processes most commonly used today are still variations of those described by Angell and Terry in 1979 in their original conceptualization of a μGC system, which took the form of a microcolumn etched into a 5 cm silicon wafer that was coated with a thin-film stationary phase for interaction with the volatile components in the flowing gas sample. Fabrication of such microcolumns is costly and cumbersome: it requires the use of specialized equipment (e.g., electron beam, plasmas, or a cleanroom for lithographic etching), generally involves etching with hazardous chemicals, and has limited compatibility with mass production. Even more problematic is deposition of the stationary phase on the microcolumn, which is generally carried out either dynamically (e.g., flowing a polymer solution through the column) or statically (e.g., filling the column with a polymer solution and evaporating away the solvent). Both of these stationary phase deposition approaches have been associated with coating imperfections, defects, and/or delamination, and a general lack of reproducibility.

### BRIEF SUMMARY

A new class of microcolumns for use in gas chromatography and a method of making such microcolumns is described herein.

According to one embodiment, a microcolumn for use in gas chromatography comprises a self-supporting polymer body that functions as a stationary phase and a structural support. The polymer body comprises an enclosed channel having a length L, height h and width w extending therethrough and one or more channel walls surrounding the enclosed channel. The one or more channel walls are integrally formed with the polymer body. The polymer body and the one or more channel walls may comprise a phase-separated polymer composition.

A stationary phase for a microcolumn used in gas chromatography comprises a phase-separated polymer composition that includes one or more matrix regions comprising a first polymer and one or more domain regions comprising a second polymer. The one or more domain regions are intermixed with or adjacent to the one or more matrix regions. The first polymer has a first permeability and the second polymer has a second permeability higher than the first permeability.

A method of making a microcolumn for use in gas chromatography comprises: casting a polymer precursor composition in a mold comprising a negative relief of a channel having a height h, width wand length L; curing the polymer precursor composition to form a polymer replica comprising the channel, the channel extending through the polymer replica from an inlet to an outlet thereof; removing the polymer replica from the mold; contacting the polymer replica with a polymer film so as to cover the channel; and bonding the polymer replica to the polymer film, thereby forming an enclosed channel and making a microcolumn for use in gas chromatography.

### BRIEF DESCRIPTION OF THE DRAWINGS

FIGS. 1A-1E are schematics of an exemplary microcolumn fabrication process, showing a cross-sectional view of each step. Step (1) shows the use of computer aided machining to make the master mold; step (2) shows the casting and curing of a thermoset polymer; step (3) shows removal of the polymer body from the mold and the sealing with a polymer film as an enclosing layer to seal the channels; and step (4) shows the insertion of capillary tubing into the inlet and outlet of the microcolumn.

FIG. 2A is an exemplary PCTFE mold that has removable sidewalls and a serpentine channel design (or pathway); FIG. 2B is close-up view of the PCTFE mold, where the scale bar is 0.5 mm.

FIGS. 3A-3D show scanning electron microscope (SEM) images of portions of an exemplary molded polymer microcolumn before (A-C) and after (D) enclosure of the microchannels; scale bars=250 μm.

FIGS. 4A-4C are SurfCam images of exemplary mold designs: A) 400 μm×450 μm×1 m serpentine channel; B) 100 μm×450 μm×1 m serpentine channel; C) 250 μm×450 μm×1 m Fermat spiral channel.

FIGS. 5A and 5B show atomic force microscope (AFM) images of a phase-separated epoxy-siloxane polymer composition formed with 10 wt. % organosilane (in this example, diethoxydimethylsilane (DEDMS)), where A is a height contrast image and B is a phase contrast image.

FIGS. 6A and 6B are SurfCam images of exemplary patterns machined into Kel-F or PEEK to make reusable plastic molds: A) 250 μm×450 μm×1 m serpentine channel design; and B) 100 μm×450 μm×3.1 m serpentine channel design.

FIGS. 7A-7C are images of exemplary micromachined PEEK molds: A) 250 μm×450 μm×1 m mold with sidewalls; (B) Top view of 100 μm×450 μm×3.1 m mold; and (C) Top view of 250 μm×450 μm×1 m mold.

FIGS. 8A-8B are SEM images of an exemplary flexible epoxy microchannel fabricated using a Kel-F mold (250 μm×450 μm×3.1 m), showing: A) channel turns; and B) channel transverse cross-section.

FIGS. 9A-9B are SEM images of an exemplary PDMS microchannel fabricated using a PEEK mold (100 μm×450 μm×3.1 m) showing: A) channel turns; and B) channel inlet/outlet.

FIGS. 10A and 10B show exemplary PDMS microcolumns after enclosing the channel: A) SEM image of a cross-section of a 100 μm×450 μm×3.1 m enclosed channel; and B) Image of 250 μm×450 μm×1 m finished PDMS microcolumn with dye filling the enclosed channel.

FIG. 11 is an image of a HP 5890 Series II GC/FID instrument used to evaluate microcolumns; the microcolumn is attached to the GC/FID system using two Nanoport fittings and fused silica capillary tubing.

FIGS. 12A and 12B are chromatograms for A) 250 μm×450 μm×1 m and B) 100 μm×450 μm×3.1 m PDMS microcolumns, where analytes are methane, butane, and pentane. Linear velocity is 16 cm s⁻¹ (head pressure=7.25 psi) and 25 cm s⁻¹ (head pressure 10 psi), respectively. Oven temperature is programmed A) 30° C. for 1 minute, ramp at 20° C./min, hold at 100° C., and B) 40° C. for 10 minutes, ramp at 20° C./min, hold at 100° C.

FIG. 13 shows a plot of film thickness vs. microcolumn efficiency (N=number of plates) for n-pentane at 40° C. in a 100 μm×450 μm×3.1 m PDMS microcolumn with a flow rate of 30 cm s⁻¹. The effective film thickness of the microcolumn made by molding of PDMS is ˜100 μm. To achieve the desired resolution, the effective film thickness may be <5 μm.

FIGS. 14A and 14B are representative chromatograms for 250 μm×450 μm×1 m DP-105 microcolumn: A) Separation of C₆-C₁₀ alkanes, linear velocity 50 cm s⁻¹ (head pressure 5 psi), oven isothermal at 35° C.; and B) Separation of C₄-C₆ alkanes, linear velocity 14 cm s⁻¹ (head pressure 1 psi), oven isothermal at 0° C.

FIG. 15 shows an optical micrograph of a 250 μm×450 μm×1 m DP-105 epoxy channel where bubbles, cavities, and surface defects are seen in contact with the channel, forming inconsistent flow paths; such defects may be caused by insufficient degassing of the epoxy precursor before curing occurs.

FIGS. 16A and 16B show optical micrographs of a DP-190 epoxy microchannel fabricated using a Kel-F mold (250 μm×450 μm×1 m). No bubbles are evident and excellent transfer of features is seen. The smooth flow path may substantially improve the performance of the microcolumn for GC separations.

FIG. 17 is a chromatogram of methane obtained using a 250 μm×450 μm×1 m DP-190 microcolumn. Linear velocity 27 cm s⁻¹ (head pressure 4 psi), oven isothermal at 35° C. Excellent peak shape is observed for methane, confirming the presence of a single flow path.

FIG. 18 shows effective theoretical plate count [calculated from 5.54*((tᵣ−tₘ)/FWHM)²] of n-alkanes analyzed using 250 μm×450 μm×1 m DP-190 10 wt. % organosilane microcolumns. The highest plate counts were achieved with the OS#7 microcolumn (cf. Table 2 for formulations).

FIG. 19 shows resolution [calculated from (tᵣ₂−tᵣ₁)/1.17*(FWHM₂₊FWHM₁)] of n-alkanes analyzed using 250 μm×450 μm×1 m DP-190 10 wt. % organosilane microcolumns. The best resolution was achieved with the OS#7 column.

FIG. 20 shows chromatograms of C₅-C₁₀ alkanes analyzed using a 250 μm×450 μm×1 m DP-190 10 wt. % OS#6 microcolumn and a 250 μm×450 μm×1 m DP-190 10 wt. % OS#7 microcolumn. The OS#6 doped column shows poorer resolution than the OS#7 doped microcolumn even though the adjusted retention times were much longer.

FIG. 21 shows chromatograms of C₅-C₁₀ alkanes analyzed using a 250 μm×450 μm×1 m DP-105 microcolumn and a 250 μm×450 μm×1 m DP-190 10 wt. % OS#7 microcolumn. The DP-105 column shows split peaks (caused by bubbles in the flow path) and poorer resolution compared to the DP-190 10 wt. % OS#7 microcolumn.

FIGS. 22A-22B show the effect of temperature on retention time and FWHM of the A) heptane and B) decane peak for a 250 μm×450 μm×1 m DP-190 10 wt. % OS#7 microcolumn. Linear velocity 27 cm s⁻¹, split ratio ˜500:1, injector port 250° C., detector 300° C. In these results, the microcolumn was not yet fully cured.

FIGS. 23A-23B show the effect of oven temperature on decane peak A) retention time and B) FWHM using a 250 μm×500 μm×1 m fully cured 10 wt. % DEDMS/DP-190 microcolumn. u=35 cm s⁻¹

FIGS. 24A-24D show the effect of curing time for OS#7 doped and undoped DP-190 microcolumns: A) Effective theoretical plate counts for C₅-C₁₀ peaks obtained from chromatogram in FIG. 24B; B) C₅-C₁₀ separation on a 250 μm×450 μm×1 m column; C) Effective theoretical plate counts for C₅-C₁₀ peaks obtained from C₅-C₁₀ separation on a 250 μm×450 μm×1 m column; and D) Chromatogram of C₁₀ peak. Oven isothermal at 35° C., linear velocity 27 cm s⁻¹, split ratio ˜500:1, injector port 250° C., detector 300° C.

FIG. 25 shows the effect of cure time on separation efficiency of a 250 μm×500 μm×1 m 10 wt. % DEDMS/DP-190 microcolumn. u=45 cm s⁻¹, oven isothermal at 35° C.

FIG. 26 shows a comparison of a 250 μm×500 μm×1 m 10 wt. % DEDMS/DP-190 microcolumn sealed with an undoped epoxy film and a 250 μm×500 μm×1 m 10 wt. % DEDMS/DP-190 microcolumn sealed a 10 wt. % DEDMS doped epoxy film. u=35 cm s⁻¹, oven isothermal at 35° C. Columns cured at 70° C.

FIGS. 27A-27C show chromatograms obtained using a 250 μm×500 μm×1 m 10 wt. % DEDMS/DP-190 microcolumn; A) Separation of n-alkanes at room temperature. u=30 cm 5⁻¹; B) Expanded scale to show the separation and resolution of first three analytes in the first 15 sec; C) Separation of eight VOCs at 35° C., inset rescaled to show elution of nonanal. u=40 cm s⁻¹. (1) n-pentane, (2) n-hexane, (3) n-heptane, (4) n-octane, (5) n-nonane, (6) n-decane, (7) acetone, (8) 1,1,1-trichloroethane, (9) trichloroethylene, (10) ethylbenzene, (11) 1,2-dichloro-benzene, and (12) nonanal.

FIGS. 28A-28D show chromatograms for n-alkane separation obtained using 10 wt. % DEDMS/DP-190 microcolumns of various geometries and cross-sections. u=65 cm s⁻¹, oven at room temperature. Peaks correspond to n-pentane, n-hexane, n-heptane, n-octane, n-nonane, n-decane in that order.

### DETAILED DESCRIPTION

This description covers the development of an easily transportable and inexpensive microcolumn for gas chromatography (GC) that can rapidly separate complex gaseous mixtures (e.g., air samples) into single components. Previous GC microcolumns have relied on materials and fabrication processes that cost hundreds or thousands of dollars, but the present device is fabricated by a novel process utilizing a thermosetting, polymerizable material and a mold-based fabrication technique that may yield unit costs well below $10. This portable and even disposable detection technology may be invaluable for gas analysis of mixtures, with diverse applications ranging from environmental to industrial to security to military chemical analyses.

An underlying assumption exists in the field of chromatography that microcolumns require both a structural support and a separate thin-film stationary phase. Traditionally, as indicated above, a lithographically patterned piece of metal or silicon is used as the structural component of the microcolumn, and a thin polymer film (e.g., polydimethylsiloxane (PDMS)) coated on the structural component acts as the separating material, the so-called “stationary phase” of gas chromatography. Existing microcolumn fabrication protocols require a patterned, micromachined piece for every microcolumn.

In sharp contrast, the novel microcolumn described herein comprises a polymer body that acts as both the structural support and as the active stationary phase and which may be produced by a rapid and inexpensive molding process. The polymer body may be formed of a polymer composition that includes one or more thermoset, thermoplastic or photo-crosslinkable polymers that permit facile removal from a mold.

For GC applications, a mixture of gases or other volatile analytes may be injected at the microcolumn inlet and carried through the microcolumn via an inert carrier gas (e.g., helium). As the analyte is carried down the microcolumn, it repeatedly adsorbs onto and sorbs/diffuses into the stationary phase and then desorbs back into the mobile (gas carrier) phase, where the analyte moves down the column at the same speed as the carrier gas. The adsorption, diffusion, and desorption rates depend on the analytes' relative affinities for the stationary phase versus the mobile phase, which causes the analytes to travel at different speeds. Consequently, analytes elute from the microcolumn at different times, allowing users to identify a mixture's components. In proof of concept experiments, the microcolumn described herein has successfully separated mixtures of six alkanes and eight volatile organic compounds and has exhibited a maximum observed effective theoretical plate count of 1600. The device can be operated at various temperatures but has worked most easily at room temperature.

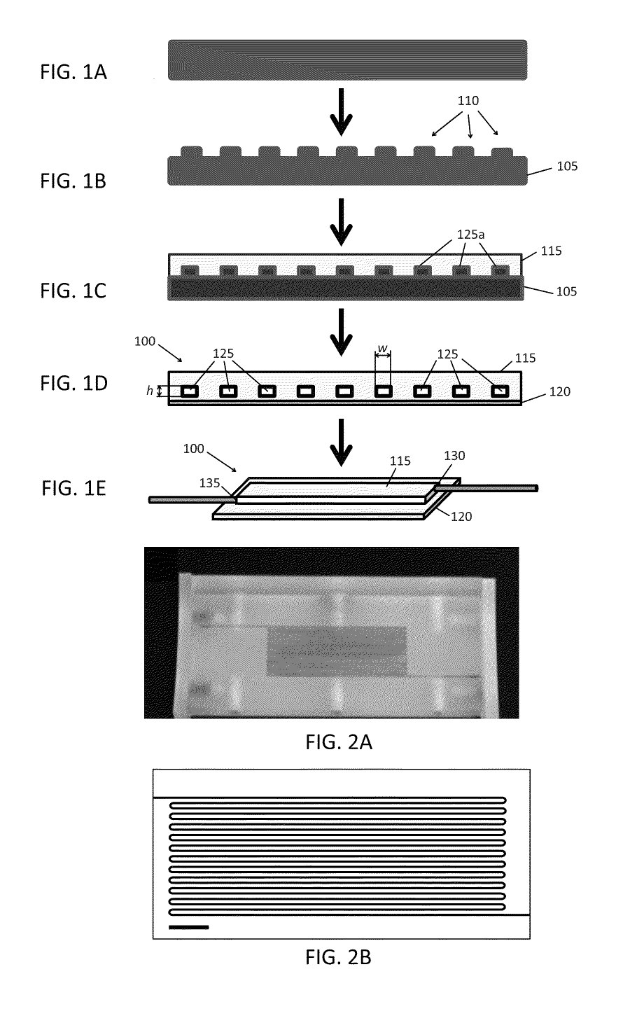

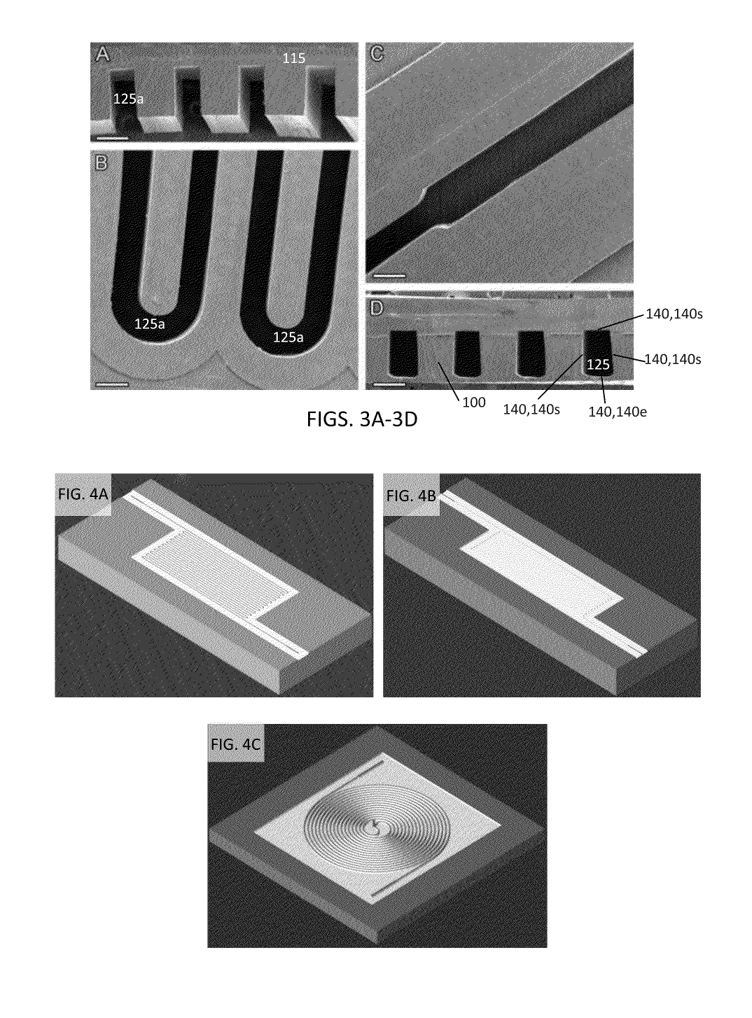

The microcolumn for use in gas chromatography comprises a self-supporting polymer body that functions both as a structural support and a stationary phase. The term “self-supporting” means that the polymer body has sufficient mechanical integrity to maintain its shape under the force of gravity at room temperature; for example, an underlying substrate or scaffold is not required to support the polymer body. The self-supporting polymer body 100 includes (a) an enclosed channel 125 having a length L, height h and width w extending therethrough and (b) one or more channel walls 140 surrounding the enclosed channel, as shown for example in FIGS. 1D and 3D. The polymer body 100 may comprise a phase-separated polymer composition. The one or more channel walls 140, which are integrally formed with the self-supporting polymer body, may also comprise the phase-separated polymer composition. The phrase “integrally-formed with” means that the polymer body and the channel walls, which are formed together in a molding process, constitute a monolithic unit.

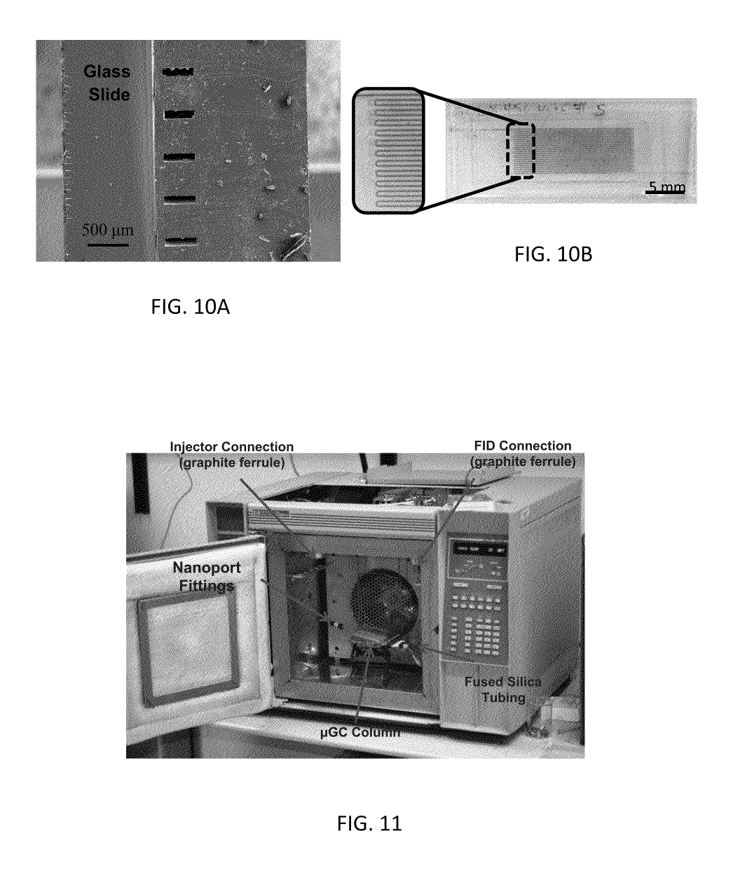

Before the microstructure and composition of the microcolumn are described in detail, it is useful to understand the microcolumn fabrication process, which is illustrated in a series of cross-sectional schematics shown in FIGS. 1A-1E. The fabrication method entails providing a mold 105 comprising a negative relief 110 of a channel 125a, as shown in FIGS. 1A-1B. A polymer precursor composition may be cast in the mold and then cured to form a polymer replica 115 comprising the channel 125a. (FIG. 10) After casting and curing, the polymer replica 115 may be removed from the mold 105. (The mold 105 may further be used multiple times (even thousands of times) to form multiple polymer replicas comprising the 3D pattern.) The polymer replica 115 and a polymer film, which may be a thin film on a substrate 120, are brought into contact so as to cover the channel 125a, and the polymer replica 115 is bonded to the polymer film, thereby forming a polymer body 100 comprising an enclosed channel 125 and making a microcolumn for use in gas chromatography (FIG. 1D). The enclosed channel 125 formed by this method extends through the polymer replica 115 or polymer body 100 from an inlet 130 to an outlet 135, as can be seen in FIGS. 2A and 2B, which show images of an exemplary channel pattern on a mold. The enclosed channel 125 has a height (or depth) h, width wand length L, where the length L is the entire length of the enclosed channel 125 from the inlet 130 to the outlet 135.

FIGS. 3A-3D show scanning electron microscope (SEM) images of portions of an exemplary molded polymer microcolumn before and after enclosure of the channel, where the scale bars are 250 microns in length. In particular, FIG. 3A shows a transverse cross-section of the channel 125a before enclosure, and FIGS. 3B and 3C show turns within a channel and a portion of a channel inlet/outlet, respectively, also before enclosure of the channel. FIG. 3D shows a transverse cross-section of a microcolumn after the channel has been enclosed (or sealed) with a polymer film.

Referring to FIG. 3D, the polymer body 100 may have a nonuniform thickness about a perimeter of the channel. More particularly, the one or more channel walls 140 that surround the enclosed channel 125 may consist of an enclosing wall 140e and one or more supporting walls 140s, where the enclosing wall 140e has a wall thickness less than that of each of the one or more supporting walls 140s. For example, the enclosing wall may comprise a wall thickness of about 200 microns or less, about 100 microns or less, or about 50 microns or less, and each of the one or more supporting walls may comprise a wall thickness of at least about 1.2 times the wall thickness of the enclosing wall. The wall thickness of each of the one or more supporting walls may also be at least about 1.5 times, at least about 2 times, at least about 2.5 times, or at least about 3 times the wall thickness of the enclosing wall.

The number of channel walls depends on the geometry of the channel. Typically, a transverse cross-section of the enclosed channel has a polygonal shape, such as a rectangle, diamond, pentagon or hexagon, where the number of sides of the polygonal shape defines the number of walls of the channel. In the case of a rectangular shape, as shown for example in FIG. 3D, there are four channel walls 140, one of the channel walls 140 being the enclosing wall 140e and three of the channel walls 140 constituting the supporting walls 140s. It is also possible that at least a portion of the transverse cross-section of the channel has a rounded shape. In this case, there may be as few as two channel walls: the enclosing wall (assuming a planar shape) and a curved wall that meets the enclosing wall to define the perimeter of the channel. If the enclosing wall is non-planar and has a radius of curvature substantially matching that of the single curved wall, then the enclosed channel may have a circular transverse cross-section and may effectively comprise a single wall that defines the perimeter (in this case circumference) of the channel. Similarly, the transverse cross-section may be an oval or other curved shape.

It has been found that the channel geometry may influence the gas separation performance of the microcolumn. In particular, as discussed below, a narrower and longer channel may be advantageous. Accordingly, the length L of the enclosed channel is advantageously at least about 0.25 m, and may be in the range of from about 1 m to about 10 m. The enclosed channel may also comprise a height-to-width ratio h/w of at least about 1, or at least about 1.5. The height-to-width ratio h/w may also be at least about 2, at least about 2.5, or at least about 3. In some cases, the height-to-width ratio h/w may be less than 1, such as about 0.5 or less, or about 0.2 or less (e.g., from 0.1 to 0.9). The height h of the channel is measured with respect to the enclosing wall, and the width w is measured in a direction parallel to the enclosing wall. The height h is typically in the range of from about 50 microns to about 600 microns, and the width w is typically in the range of from about 50 microns to about 500 microns.

The enclosed channel is continuous from the inlet to the outlet and may follow any of a variety of pathways through the polymer body. Advantageously, the selected pathway allows the length of the enclosed channel to be maximized without compromising the structural integrity of the polymer body. As shown by the mold designs of FIGS. 4A-4C, the polymer body may include, for example, an enclosed channel following a rectangular serpentine pathway (FIGS. 4A-4B). The enclosed channel may alternately follow another pathway, such as a Fermat spiral (FIG. 4C), or square double spiral. The mold may comprise any of a number of geometric pathway designs, such as a hybrid of the serpentine and spiral pathways.

Advantageously, the polymer composition of the polymer body and the channel walls may be a phase-separated polymer composition comprising (a) one or more matrix regions comprising a first polymer; and (b) one or more domain regions comprising a second polymer that are intermixed with or adjacent to the one or more matrix regions, where the first polymer has a first permeability and the second polymer has a second permeability higher than the first permeability. Such a phase-separated polymer composition may be described as a composite of polymers having higher and lower permeabilities. As used herein, “permeability” refers to the polymer's ability to absorb gaseous analytes, and specifically is the product of solubility (partition) of an analyte vapor or gas in a polymer and diffusivity. In some embodiments, the second permeability may be at least about 5 times, at least about 10 times, or at least about 20 times greater than the first permeability. For example, the first permeability may be about 100 barrer or less, and the second permeability may be greater than 100 barrer, where the barrer is a non-SI unit of gas (specifically O₂) permeability; one barrer is 10⁻¹¹ (cm³ O₂) cm⁻¹ s⁻¹ torr⁻¹. The second permeability may also be about 120 barrer or greater, about 160 barrer or greater, or about 200 barrer or greater, while the first permeability may be about 70 barrer or less, about 40 barrer or less, or about 10 barrer or less. Generally, the second permeability is no higher than about 1000 barrer, and the first permeability is no lower than about 1 barrer.

The morphology of the phase-separated polymer composition may be represented on a continuum from (1) isolated islands (or domains) comprising the second polymer in a matrix comprising the first polymer to (2) an increased density of islands comprising the second polymer on a surface of a matrix comprising the first polymer to (3) interconnected islands of the second polymer dominating a surface of a matrix comprising the first polymer to (3) a surface film (a continuous domain structure) predominantly comprising the second polymer over a buried matrix comprising the first polymer. The particular morphology that forms may depend on a number of factors, including the composition, surface energy, and concentration of each of the polymers in the phase separated composition.

While a phase-separated polymer composition may have advantages for the performance of the microcolumn as described below, it is also contemplated that the polymer body and the channel walls formed in the molding process may comprise a polymer composition that is not a phase-separated polymer composition. In this case, a thin coating comprising a polymer of a suitably high permeability may be applied after molding to one or more of the channel walls or to the enclosing layer placed on top of the channel of the polymer body to serve as a thin-film stationary phase. Accordingly, one or more of the enclosing and supporting walls of the enclosed channel may include a high permeability polymer film thereon. In another example, it is contemplated that the polymer body and the integrally formed channel walls may comprise the phase-separated polymer composition as described above and may further include a coating comprising a polymer of a suitably high permeability deposited on one or more of the channel walls to function as an additional stationary phase. In each of these cases, the coating comprising the high permeability polymer may be applied by vapor deposition, drop casting, spin casting, or another coating method known to those skilled in the art.

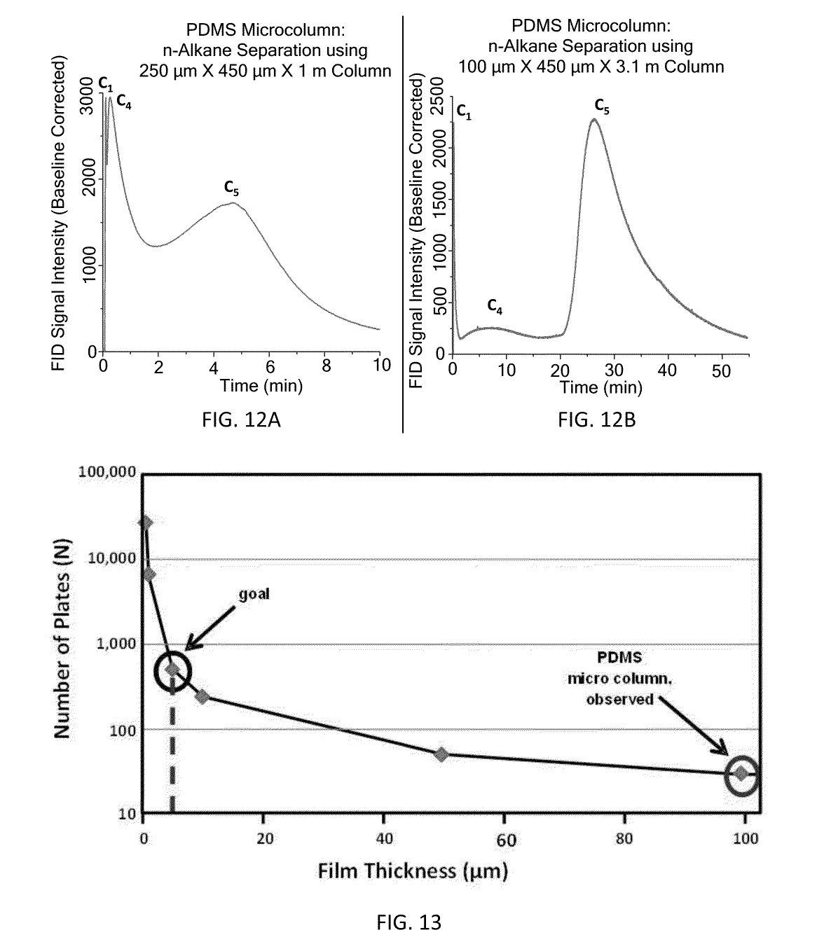

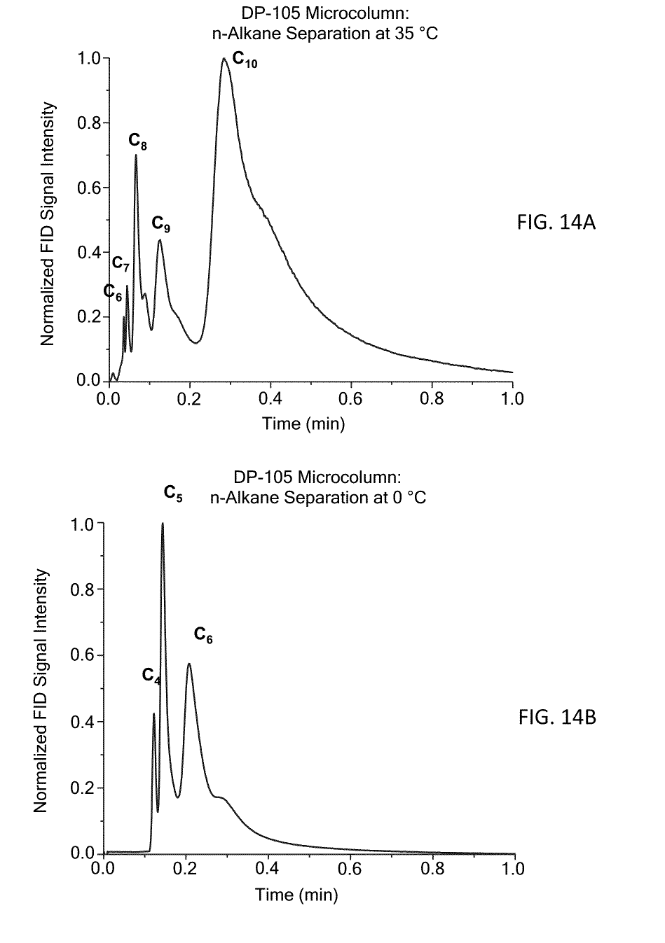

Because the stationary phase of the microcolumn described herein is not limited to a thin film, as with conventional microcolumns, the polymer permeability as well as the polymer-analyte interaction of the polymer composition (stationary phase) have been considered in the present work. If the microcolumn is made entirely from a polymer that is highly permeable, such as PDMS, the device exhibits broad analyte bands, poor resolution, and extremely long retention times, as shown in FIGS. 12A and 12B. Alternatively, if the microcolumn is made entirely from a polymer such as epoxy that has a very low permeability, the device has poor resolution, low peak capacity, and very short retention times, also as shown in FIGS. 14A, 14B and 17.

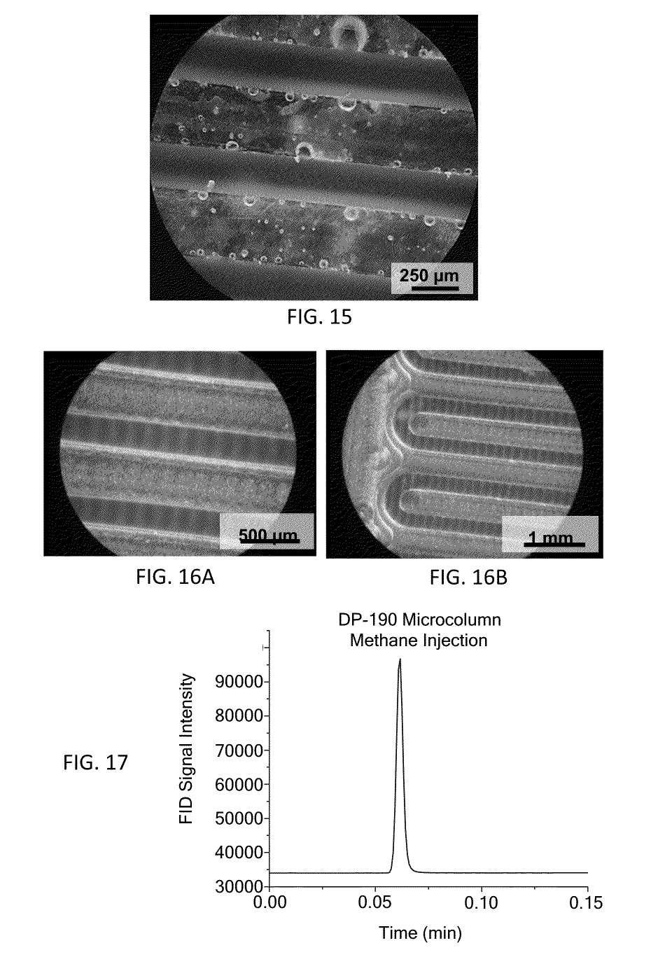

In addition, given the microcolumn fabrication approach used here, it is beneficial that the selected polymer precursors for the polymer precursor composition have low viscosity and a sufficiently long cure time to facilitate degassing of the polymer precursors. If gas bubbles are present in the polymer precursor composition during curing, the resulting microcolumn may have include channel defects (as shown in FIG. 15) that lead to band broadening and multiple peaks per component, as shown for example in FIGS. 14A and 14B.

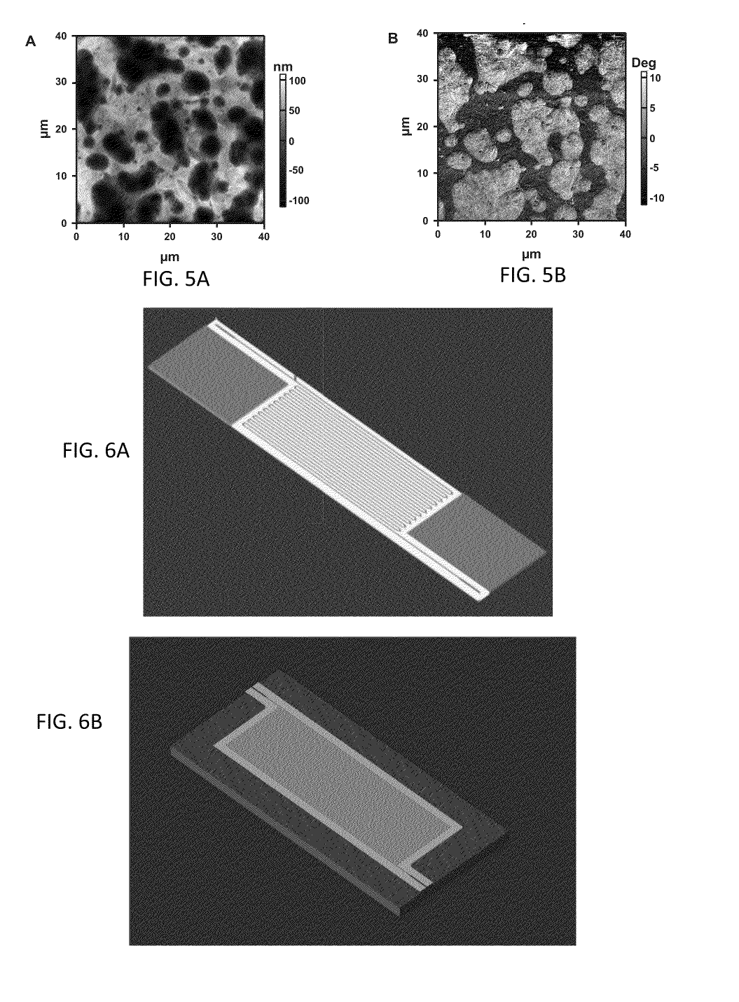

The inventors have discovered that the processing and permeability criteria described above may be met by doping a relatively impermeable polymer with a higher permeability polymer that has strong interactions with gaseous analytes. Promising gas separation results have been obtained from a phase-separated polymer composition in which the lower permeability polymer (the “first polymer”) comprises an epoxy and the higher permability polymer (the “second polymer”) comprises a siloxane. Epoxies exhibit low permeabilities that may be further decreased with increased curing time, while siloxanes have much higher permeabilities. Such a polymer composition may be referred to as an epoxy-siloxane composite in which siloxane-containing regions are dispersed within epoxy-containing regions, as shown for example in the atomic force microscope (AFM) images shown in FIGS. 5A and 5B. It is believed that the siloxane-containing regions actively participate in gas separation while the more impermeable epoxy regions act primarily as a built-in structural support. To achieve this microstructure, a polymer composition that includes a second polymer at a concentration of from about 0.5 wt. % to about 30 wt. % may be advantageous. It has been found, for example, that good results may be obtained from an epoxy-siloxane composite with a siloxane concentration of about 10 wt. %.

The phase-separated or composite polymer composition containing higher and lower permeability regions is advantageous because some portion of the domain regions comprising the higher permeability polymer (e.g., siloxane) are in gaseous communication with the channel. In other words, at least some of the domain regions are present at surfaces of the channel walls exposed to the enclosed channel. Consequently, some fraction of the domain regions in the phase-separated polymer composition are in contact with gas species passing through the channel during use of the microcolumn. Since the domain regions at the channel wall surfaces are partially surrounded by the matrix regions comprising the lower permeability polymer (e.g., epoxy), gas species entering the domain regions are prevented from diffusing too far into the bulk of the polymer body. The phase-separated polymer composition is therefore effective in limiting analyte interactions to occur within approximately 50 nm to a few μm from the channel wall surfaces. The polymer body comprising the phase-separated polymer composition may therefore function similarly to a thin-film stationary phase while providing the mechanical integrity of a bulk structure.

It is now useful to return in more detail to the fabrication process illustrated schematically in FIGS. 1A-1E. As introduced above, the process may include mold fabrication, replica molding, device sealing, and also tube connecting.

The polymer precursor composition cast into the mold to form the polymer replica may be a thermosetting composition that includes a pre-polymer base, an accelerator or curing agent, and a pre-polymer dopant or additive. Table 1 shows exemplary components for flexible epoxies available from 3M, specifically, DP-105, -190, and -125 epoxies, and Table 2 shows exemplary organosilane reagents used as additives for the DP-190 epoxy.

TABLE 1
Components for part A (accelerator) and part B (epoxy precursor) for
3M flexible epoxies DP-105, DP-190, and DP-125 (values in wt. %)

| | DP-105 | | DP-190 | | DP-125 | |
|---|---|---|---|---|---|---|
| | A | B | A | B | A | B |
| 4-4-(1-methylethylidene)biscyclo- | — | 70-80 | — | 30-40 | — | 15-40 |
| hexanol with (chloromethyl) oxirane | | | | | | |
| Poly(bisphenol A-co-epichlorohydrin) | — | 20-30 | — | 60-70 | — | 60-85 |
| (3-glycidyloxypropyl)trimethoxysilane | — | 0.5-1.5 | — | 0 | — | 0 |
| Mercaptan Polymer (trade secret) | 60-70 | — | — | — | — | — |
| Polyamine-polymercaptan blend | 30-40 | — | — | — | — | — |
| (trade secret) | | | | | | |
| Bis(dimethylaminoethyl)ether | 1-3 | — | — | — | — | — |
| 1,8-diaxabicyclo[5.4.0]undec-7-ene | 0.5-1.5 | — | — | — | — | — |
| Aliphatic polymer diamine | — | — | 70-90 | — | 70-90 | — |
| C-18 unsatd, dimers, polymers w/ | | | | | | |
| 4,7,10-trioxatridecane-1,13- | | | | | | |
| diamine | | | | | | |
| 4,7,10-trioxatridecane-1,13-diamine | — | — | 10-30 | — | 10-20 | — |
| Calcium trifluoromethanesulfonate | — | — | 1-5 | — | 1-10 | — |
| Toluene | — | — | <=0.98 | — | <1 | — |

TABLE 2
Exemplary organosilane reagents for use as additives (dopants)

| | Name | Structure |
|---|---|---|
| OS#1 | (3-glycidoxypropyl)triethoxysilane | 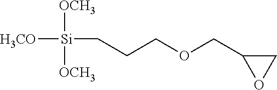 [SMILES: CO[Si](CCCOCC1CO1)(OC)OC] |
| OS#2 | Octyltriethoxysilane | 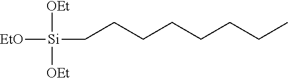 [SMILES: CCCCCCCC[Si](OCC)(OCC)OCC] |
| OS#3 | Diphenyldimethoxysilane | 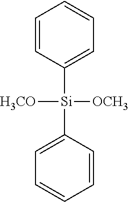 [SMILES: CO[Si](OC)(c1ccccc1)c1ccccc1] |
| OS#4 | Ethoxytrimethylsilane | 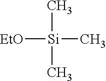 |
| OS#5 | Phenyltrimethoxysilane | 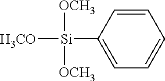 [SMILES: CO[Si](OC)(OC)c1ccccc1] |
| OS#6 | Dodecyltriethoxysilane | 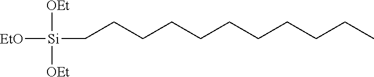 [SMILES: CCCCCCCCCCC[Si](OCC)(OCC)OCC] |
| OS#7 | Diethoxydimethylsilane | 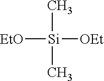 |
| OS#8 | Propyltrimethoxysilane | 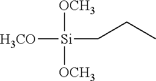 |
| OS#9 | (3-glycidoxypropyl)dimethylethoxysilane | 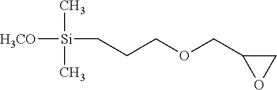 |

After casting, the polymer precursor composition may be degassed under vacuum, and then cured to form the polymer replica comprising a desired polymer composition. As explained above, the polymer composition is advantageously a phase-separated polymer composition. Generally speaking, the curing entails heating the polymer precursor composition at a temperature of at least about 70° C. for at least about 24 hours although the preferred time and temperature may be dependent on the particular polymer precursor composition selected. Typically, the polymer film and the polymer replica have the same dopant and wt. %, but not necessarily the same impermeable polymer phase. It is contemplated, however, that the polymer film and the polymer replica may have different polymer compositions.

The bonding of the polymer replica and the polymer film after covering the microchannel may entail pressing the polymer replica and film together by hand, followed by a curing (heating) step. The curing step may be carried out at a temperature of at least about 25° C. and/or a time duration of at least about 120 minutes although the preferred time and temperature may be dependent on the particular polymer precursor composition selected. In addition, before the polymer replica and the thin film are brought into contact to form the microcolumn, the surfaces of one or both may be activated by, for example, exposure to a plasma. In some cases, the method may further include removing the substrate from the polymer film after the bonding process.

Alternatively, the polymer replicas may be made from a photo-crosslinkable polymer with sufficient elastomeric properties to permit facile removal from the mold, with the polymer precursor exposed to light while held in the mold. Also alternatively, injection molding of the polymer replicas is contemplated using a thermoplastic or thermosetting polymer with sufficient elastomeric properties to permit facile removal from the mold.

After bonding, tubing may be inserted into the inlet and outlet of the enclosed channel to facilitate flow of gas mixtures into the microcolumn for detection and analysis. For example, polyimide-coated fused silica capillary tubing may be inserted into the column inlet and outlet and then secured using a thermoset polymer. The tubing may be connected to a commercially available flame ionization detector system (e.g., Agilent/HP-5890 Series II GC/FID) or a mass selective detector (e.g., Agilent 5975 MSD) for evaluation.

The mold used for the process may be formed by micromachining or lithography/etching methods known in the art. In the examples discussed below, the mold is made by micromachining either polychlorotrifluoroethylene (PCTFE) or poly ether-ether ketone (PEEK) with the negative relief (or inverse) of a serpentine channel design, as shown in FIG. 2A-2B. Other suitable materials for the mold may include machinable materials such as machinable ceramics (e.g., Macor, alumina, etc.), metals (brass, aluminum), or others (silicon, ABS, PVC, UHMWPE, etc.). Micromachining is generally preferred over lithography for mold fabrication because the former is relatively fast and does not require a cleanroom or hazardous chemicals. The PCTFE and PEEK molds created as described below have proven to be highly durable, showing no signs of defects after more than 50 uses. Additionally, the molds may not require silanization or treatment with a release agent to aid in removal of the cured polymer composition, another advantage over molds made from metals, silica, or photoresist via lithography.

### Microcolumn Fabrication

### Examples

### 1.1 Mold Fabrication

Micromachining was used to fabricate a polymer mold with the negative relief of the final column design. The polymers employed in these experiments were polyether ether ketone (PEEK) and polychlorotrifluoroethylene (PCTFE or Kel-F). Representative images of the SurfCam CAD/CAM blueprints for these molds are shown in FIGS. 6A and 6B. The mold channels are rectangular in cross-section and spaced 400 μm apart. The inlet and outlet extend to the edge of the mold and are 450-600 μm wide, and the sidewalls are positioned >1 cm from the channel features. During fabrication, the channel features and surrounding 3-4 mm are machined without end mill pickup (see lighter regions of FIGS. 6A and 6B) to ensure the replica has a smooth sealing surface. Then, the rest of the mold (darker regions of FIGS. 6A-6B) is milled smooth. To ensure that the channels are first to contact the thin film in the sealing step, it is important that the z-plane of the darker section be 30-100 μm higher than the lighter section.

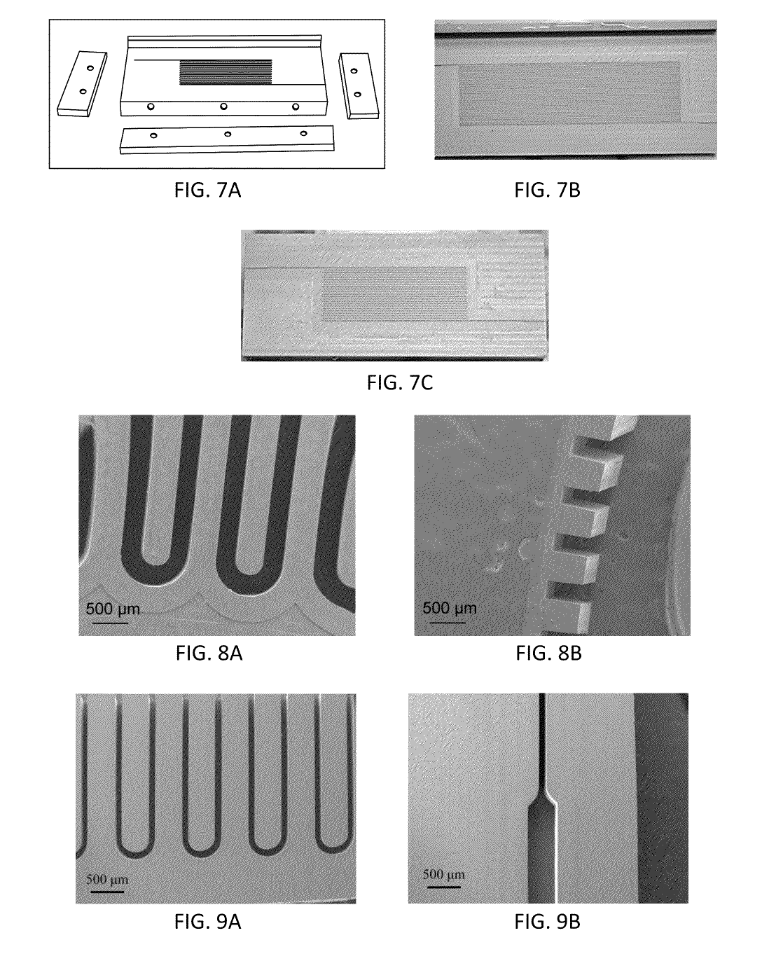

Each mold has four removable sidewalls that screw into the base, as shown in FIG. 7A. Micromachining was chosen over lithography for mold fabrication since micromachining does not require the use of a cleanroom or the use of hazardous chemicals. The Kel-F molds used for epoxy and PEEK molds used for polydimethylsiloxane (PDMS) are highly durable, showing no signs of defects after ≧50 uses, and do not require silanization or treatment with a release agent to aid in cured epoxy polymer removal. FIGS. 7B and 7C show two examples of PEEK molds.

### 1.2 Replica Molding

The features of the Kel-F mold were replicated using different flexible epoxies, as discussed further below. The accelerator, epoxy precursor, and (in some cases) organosilane are mixed in the appropriate ratio, and the mold is filled with the uncured polymer. The polymer is degassed in a vacuum oven at 40° C. until all bubbles are removed (time is formulation dependent) then cured for 24 hours at 70° C. The cured epoxy is allowed to cool for one hour at room temperature, the sidewalls of the mold are unscrewed and removed, and the column is peeled carefully from the mold by hand. SEM images of an exemplary patterned epoxy are shown in FIGS. 8A-8B.

The features of the PEEK mold were replicated using PDMS from Dow Corning (Sylgard 184). For PDMS replica molding, the polymer precursor base and curing agent were mixed in a 10:1 m/v ratio, degassed in a vacuum oven for 20 minutes, poured into the mold, degassed again, and cured at 100° C. for 45 minutes. After cooling, the PDMS replicas were removed from the mold by hand. SEM images of a patterned PDMS replica are shown in FIGS. 9A-9B.

### 1.3 Sealing or Enclosing of the Microchannel

To seal the epoxy microchannel, a film was made by spreading 3M DP-125 flexible epoxy on a glass microscope slide with a spatula (1″×3″ standard microscope slide for 1 m design and 3″×4″ glass slides for 3.1 m design). The glass slides are merely used as a convenience, and the film could be easily cast on a piece of Kel-F and then removed after curing to form a free-standing all-polymer device. The films were left at room temperature for two hours, during which time the film self-leveled. The epoxy microchannels were lightly pressed by hand against the tacky film while visually for defects and air bubbles. The bonded pieces were immediately placed in a drying oven and cured at 70° C. for 12 hours.

To seal the PDMS microchannel, a 100 μm PDMS film (10:1, Sylgard 184) was cast on a glass slide (1″×3″ standard microscope slide for 1 m design and 3″×4″ brain research slide for 3.1 m design) using a spin-coater at 1,000 rpm for 60 seconds then cured at 100° C. for 45 minutes. After activating the surfaces with a Tesla coil (i.e., atmospheric plasma), the film and PDMS channel were lightly pressed together by hand while visually checking for defects and air bubbles, and then the bonded pieces were cured at 100° C. for 45 minutes. A cross-sectional image of the resulting sealed microcolumn is given in FIG. 10A, and the flow path of a sealed microcolumn is provided in FIG. 10B.

### 1.4 Forming External Connections to the Microcolumn

Nanoport fittings are traditionally used to connect tubing to microfluidic devices; however, these fittings are expensive and can significantly increase the cost of the microcolumn. An 8-cm length of polyimide coated fused silica tubing (360 μm O.D., 150 μm I.D.) from IDEX was inserted into each column inlet and outlet by hand. The tubing was sealed with uncured PDMS for PDMS microcolumn devices or DP-125 for the flexible epoxy microcolumn devices and then cured by heating.

### Microcolumn Performance

### Experimental Results

### 2.1 Procedure

To probe the separation performance of the microcolumns, a mixture of n-alkanes, typically a combination of C₁ or C₄-C₁₀, was injected into the microcolumns. A 5890 Series II GC/FID System, shown in FIG. 11, was used for the experiments, and the appropriate analytes were obtained from Sigma Aldrich. The linear velocity and oven temperature were adjusted to achieve the best chromatogram possible and therefore vary from column to column. Generally, the carrier gas used was helium, the injector port was held at 250° C., the FID was held at 300° C., the split ratio was ˜500:1, and 0.1-1 μL of analyte mixture was injected manually. Data were collected at a rate of 20 Hz via Chemstation Software (Rev. A.10.02) and analyzed using Origin. Separation efficiency was quantified and compared via common chromatography metrics, such as number of theoretical plates (N or N_{eff})) plate height (H), retention time (tᵣ), full width at half max (FWHM), resolution (Rₛ), tailing factor (T_{f}), and column capacity (n). Typically, values were calculated using the last eluting peak in a given experiment.

### 2.2 PDMS Microcolumns

Initially, the microcolumns were made using PDMS because it is inexpensive, commercially available, and extremely commonly used for microfluidic devices. These microcolumns successfully separated methane, butane, and pentane; however, the retention times were long and peaks were broad and had significant tailing (FIGS. 12A and 12B). In fact, alkanes of higher molecular weight than n-pentane would not elute from the column. Using a formula derived from literature that relates column film thickness to separation efficiency for n-pentane in the PDMS micro-column (Equations 1-3), and empirical values for n-pentane retention time, FWHM, and column efficiency (Table 4), it was determined the microcolumn behaves as if it were a film approximately 105 μm thick, a value substantially smaller than the actual thickness of the PDMS. This finding suggests that the bulk interior of the PDMS is inaccessible to n-pentane on the time-scales and pressures used in these experiments. Unfortunately, to achieve a reasonable separation efficiency (N=500 plates), the film thickness would have to be <5 μm, as shown in FIG. 13, which uses Equations 1-3. This very thin film thickness, which would be necessary due to the inherent high permeability of silicone polymers, would be very difficult to obtain using the current fabrication method. Therefore, less permeable polymers with a much lower silicone content were used to try to achieve high plate counts without altering the easy and inexpensive fabrication process.

$$\begin{matrix}H = \frac{6 {K}^{′}}{{( 1 + {K}^{′} )}^{2}} \frac{{d}_{f}^{2}}{{D}_{l}} \overline{u} & ( Equation 1 ) \\ {K}^{′} = \frac{RT ρ}{{y}^{∞} {P}^{O} M} \frac{{V}_{L}}{{V}_{g}} & ( Equation 2 ) \\ {V}_{L} = 310 ( 4 {d}_{f} + 0.106 {d}_{f} ) & ( Equation 3 )\end{matrix}$$

TABLE 4
Values for Equations 1-3.

| Dₗ | 9.5 × 10⁻⁶ | cm² s⁻¹ |
|---|---|---|
| ū | 30 | cm s⁻¹ |
| R | 0.0821 | atm L mol⁻¹ K⁻¹ |
| T | 313 | K |
| P⁰ | 1.053 | atm |
| ρ | 1030 | g L⁻¹ |
| Y^{∞} | 0.00494 | |
| M | 100,000 | g mol⁻¹ |
| V_{g} | 0.1333 | cm³ |

### 2.3 Epoxy Microcolumns

Flexible epoxies are commercially available from 3M, are relatively easy to process, and readily release from the Kel-F molds. Their compositions are detailed in Table 1. Microcolumns fabricated from the flexible epoxy show substantially better resolution, shorter retention times, higher separation efficiency, and greater peak capacity than PDMS columns of the same design, as shown in Table 5.

TABLE 5
Comparison of separation characteristics for a 250 μm ×
450 μm × 1 m PDMS microcolumn and a 250 μm ×
450 μm × 1 m DP-105 epoxy microcolumn. Separations
were run at similar linear velocities, but the PDMS
microcolumn was temperature programmed and the epoxy
column was run at 0° C.

| | PDMS | | DP-105 | |
|---|---|---|---|---|
| | (Temp-programmed) | | (0° C.) | |
| Head Pressure | 7.25 | psi | 1 | psi |
| Retention Time (pentane) | 4.69 | min | 0.098 | min |
| FWHM (pentane) | 4.93 | min | 0.0153 | min |

| | | |
|---|---|---|
| N (plate count) (pentane) | 5 | 486 |
| Resolution (C₄-C₅) | 0.5 | 0.5 |
| % Pentane in Stationary Phase | 99.2% | 24.8% |

Given the appropriate experimental conditions, the DP-105 microcolumn can easily separate mixtures of low molecular weight alkanes, as shown in FIGS. 14A and 14B. The DP-105 microcolumn, however, is imperfect and shows split peaks for low molecular weight alkanes and very broad tailing peaks for high molecular weight alkanes. The most likely cause of the broad, split peaks is multiple flow paths caused by bubbles and resulting pits and indentations in contact with the gas flow channel, as can be seen in FIG. 15. These bubbles were caused by the inability to fully degas the epoxy before it enters the gel phase due to the very rapid cure time of DP-105.

To solve the inconsistent flow path problem, DP-190, a low viscosity flexible epoxy with a longer cure time (90 minute tack-free time), was examined as a replacement for the DP-105 epoxy (5 minute tack-free time). The bubbles were successfully eliminated via degassing the monomers and the mixed DP-190 epoxy in a vacuum oven at 40° C. Optical micrographs of the bubble-free channel can be seen in FIGS. 16A-16B. The DP-190 column gives an asymmetry factor of 1.02 for the methane peak (FIG. 17), confirming the presence of a single flow path. However, this column is unsuccessful in separating a mixture of n-alkanes. This lack of analyte separation is caused by the low permeability of the DP-190 polymer and to the decreased channel surface area in the DP-190 columns due to the absence of bubbles that are otherwise present in the channels of the DP-105 columns. So, pure DP-190 epoxy does not provide sufficient interaction with the analytes to provide significant separation among them during the transit time through the microcolumn. To alleviate that problem, doping monomers were added to form a surface capable of better interaction with analytes, as described in the next section.

### 2.4 Epoxy-Siloxane Microcolumns

Nine different organosilane monomers were investigated as additives to DP-190 in order to provide greater interaction between the microcolumn channel walls and the gas phase analytes. The organosilanes were added to the epoxy precursor and mixed well. The base and accelerator were then mixed, cast, degassed, and cured as described previously for DP-190. A series of 250 μm by 450 μm by 1 m columns doped with 10 wt. % of each organosilane were made. The organosilanes investigated are given in Table 2. All columns were tested with the injector port at 250° C., oven isothermal at 35° C., FID detector temp at 250° C., and split ratio ˜500:1. First, methane was injected to ensure a defect free pathway (necessary for good peak shape) and a linear velocity of 27 cm s⁻¹ (tₘ=0.061 min). The adjusted retention time, FWHM, effective plate count, and resolution were compared for each column in the 10 wt. % organosilane series. All of the organosilane doped columns had longer retention times for the n-alkanes tested than the undoped DP-190 column; however, only OS#2, OS#6, and OS#7 significantly increased the retention times for lower molecular weight alkanes (≦C₈).

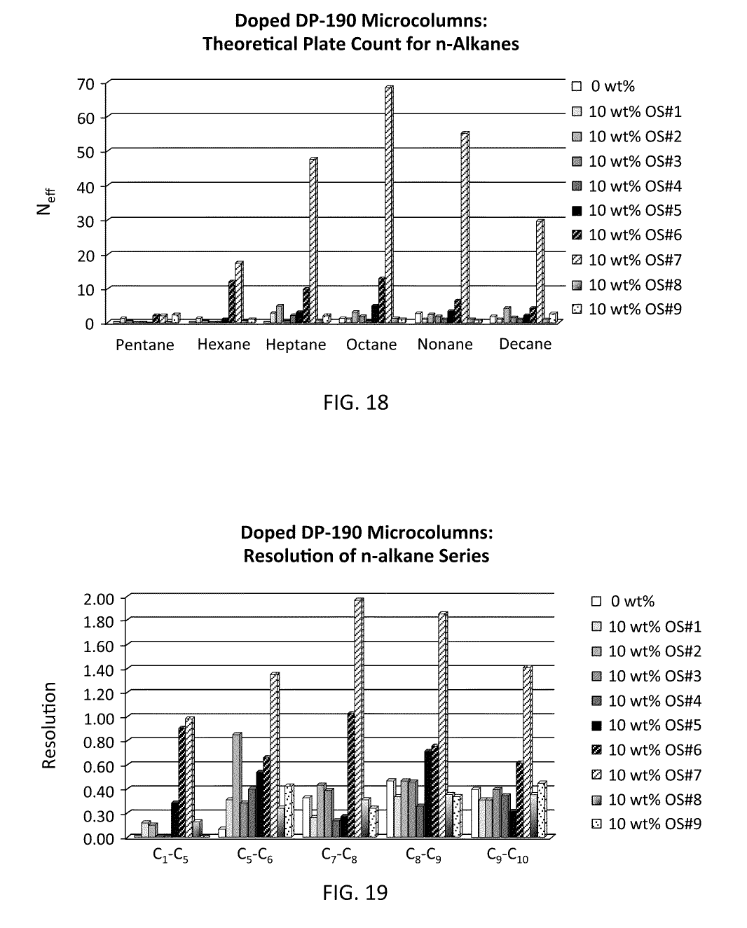

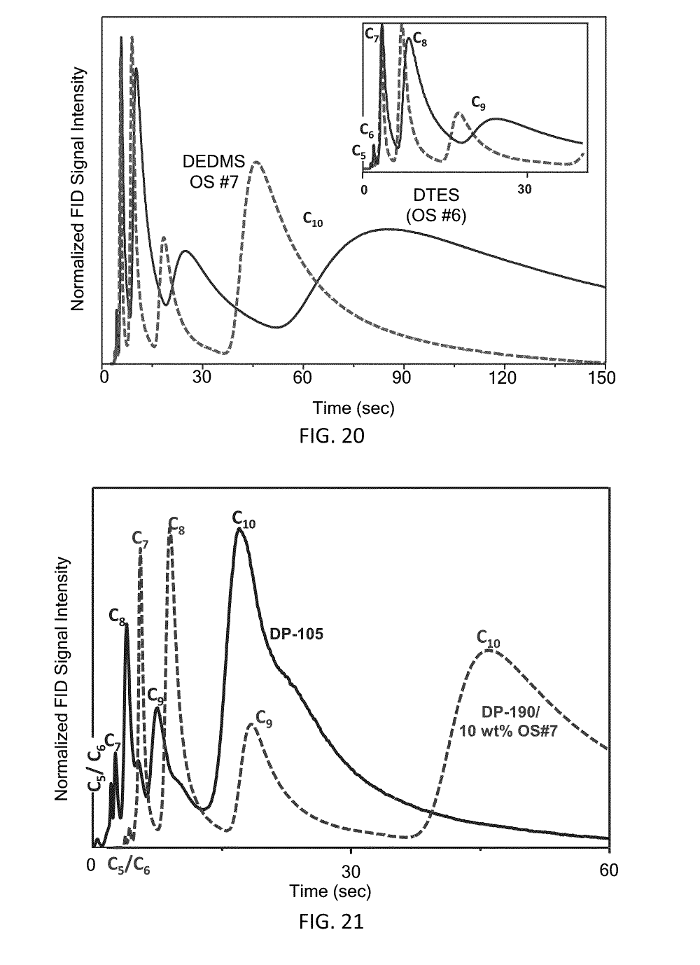

In general, the columns that displayed the largest increase in retention time also showed the largest increase in band broadening. A notable exception is the column doped with OS#7, which shows a relatively low amount of band broadening. This translates into higher effective theoretical plate values and better resolution of sequential alkanes for the 10 wt. % OS#7 doped column compared to the other columns in the series. The effective theoretical plate counts and resolutions are given in FIGS. 18 and 19, respectively. Resolution values are erroneously high and do not fully account for the significant tailing of the analyte peaks. A qualitative comparison of the OS#6 and the OS#7 doped columns is shown in FIG. 20. The separation observed with the OS#7 doped DP-190 column is substantially better than that of the DP-105 column reported previously, as shown qualitatively in FIG. 21.

Because the structural walls of the microcolumn channel are the stationary phase with which the analytes interact, the separation mechanism for this device is much more dependent on polymer permeability than in the case of traditional microcolumns. Analyte retention time and peak width are dependent on both analyte/polymer interactions and stationary phase permeability. Thus, a highly permeable polymer may result in excessive peak tailing. Ideally, the polymer used for the microcolumn will interact strongly with the analytes of interest, have non-hysteretic analyte adsorption and desorption, and have limited permeability, due either to formation of a continuous film of permeable polymer at the surface or to discrete islands of a permeable polymer on or in the surface of the less permeable supporting polymer.

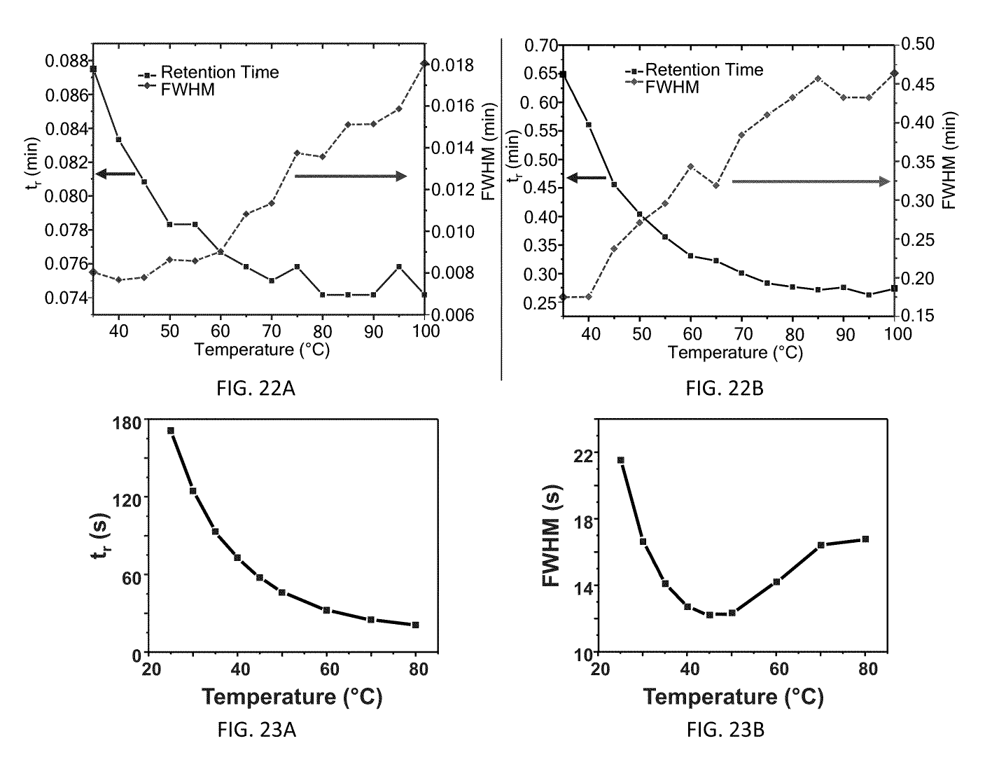

Conducting a study of the column's separation behavior at a range of temperatures gives insight into the column's separation mechanism. For these studies, a 250 μm×450 μm×1 m DP-190 10 wt. % OS#7 microcolumn was used to evaluate the effect of temperature (35° C.-100° C.) on heptane and decane retention time and peak width as is shown in FIGS. 22A and 22B. These data support the importance of permeability in the separation mechanism of this device. Since polymer permeability increases with increasing temperature, the adsorbed analyte permeates further into the polymer stationary phase, which results in wider peaks.

Interestingly, even after the microcolumn is allowed to fully cure, separation efficiency effects similar to those described above are observed at elevated temperatures. FIGS. 23A-23B show that the described microcolumn behaves as theory predicts with increasing oven temperature during a chromatographic run (i.e., decreasing retention time and FWHM with increasing temperature) until ˜45° C. At temperatures above 45° C., the peak FWHM increases and peak shape rapidly deteriorates. This further suggests the presence of multiple separation mechanisms. One potential explanation is that the epoxy domains become more permeable to analytes at elevated temperatures, increasing the role of the epoxy domains in the microcolumn's overall separation efficiency.

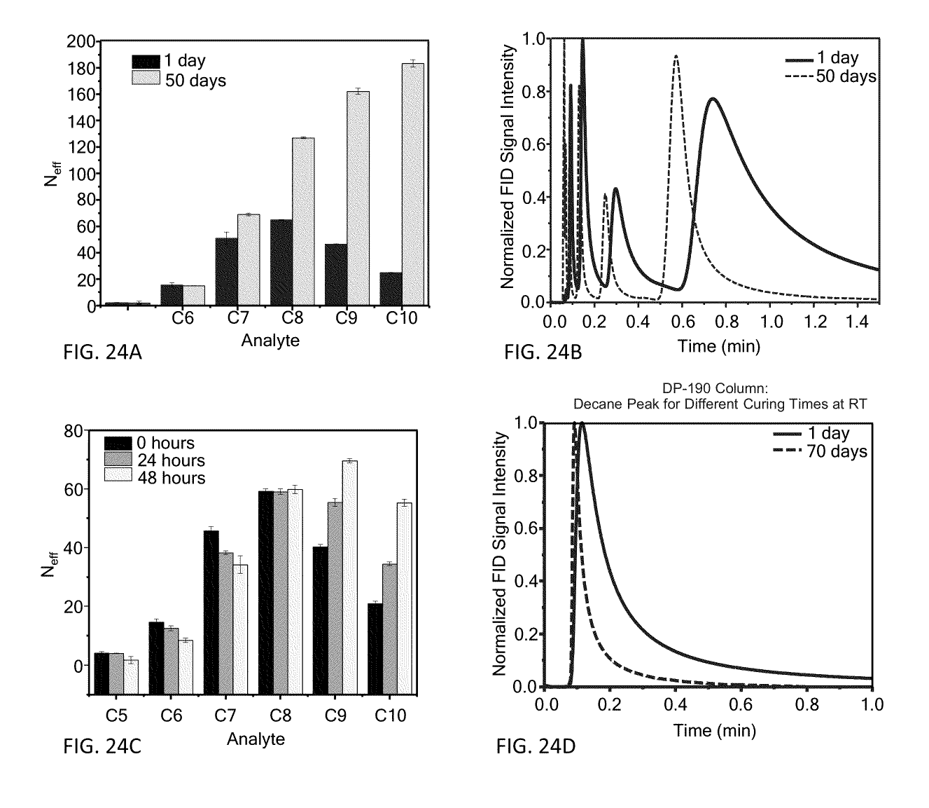

In re-testing some of the first fabricated DP-190 microcolumns months later, it became clear that increasing the cure time of the epoxy (which increases the crosslinking and decreases the permeability) can substantially improve the separation characteristics. The first DP-190 10 wt. % OS#7 column tested had a maximum theoretical plate count of 68 plates (for C₇), which increased to 183 plates (for C₁₀) 50 days later, as shown in FIG. 24A. FIG. 24B shows that this improved separation efficiency is due to a dramatic decrease in peak width and tailing. These results were mimicked in another column (12.5 wt. % OS#7 doped DP-190) but with shorter curing intervals (FIG. 24C). By allowing the epoxy to fully cure, the PDMS-like surface domains of the channel walls dominate the separation, leading to narrower peaks. Monitoring the change in a pure DP-190 column without added organosilane further supports this mechanism, as is shown in FIG. 24D.

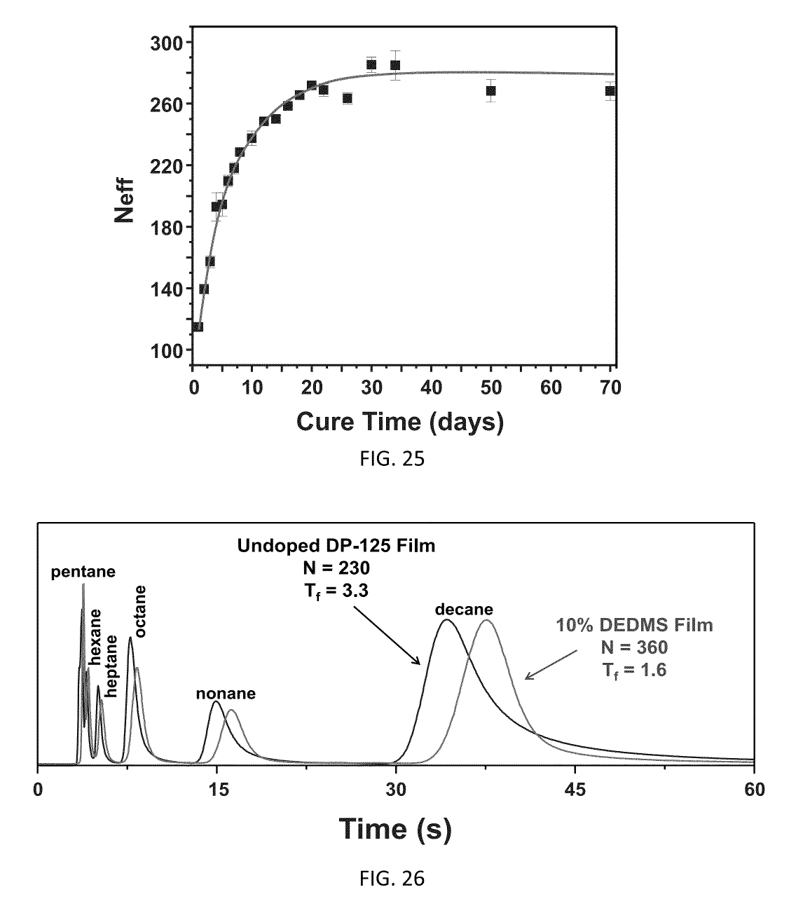

Additional insight into the separation characteristics can be gained by monitoring the separation efficiency of a microcolumn with respect to cure time of the polymer composition. FIG. 25 shows that separation performance continues to improve with cure time until ˜25-30 days when the efficiency plateaus. These data are consistent with the hypothesis that the epoxy regions further cross-link and harden, becoming less permeable to analytes, as the microcolumn cures. Before the microcolumn is fully cured, two separation mechanisms are active: (1) interaction between the analytes and siloxane-rich domains, and (2) interaction between analytes and epoxy domains. Competing separation mechanisms yield broad, tailing peaks with long retention times. As the epoxy domains harden, the microcolumn separation is increasingly governed by the analyte interaction with the siloxane-rich domains. This results in an increase in separation efficiency, and a decrease in retention time, peak width, and peak tailing. The importance of a single separation mechanism is further demonstrated when the chromatogram of a microcolumn sealed with an undoped epoxy film is compared to that obtained from a microcolumn sealed with a DEDMS doped epoxy film (FIG. 26). All subsequent experiments used columns sealed with a DEDMS doped epoxy film that had been cured for 30 days in an oven at 70° C.

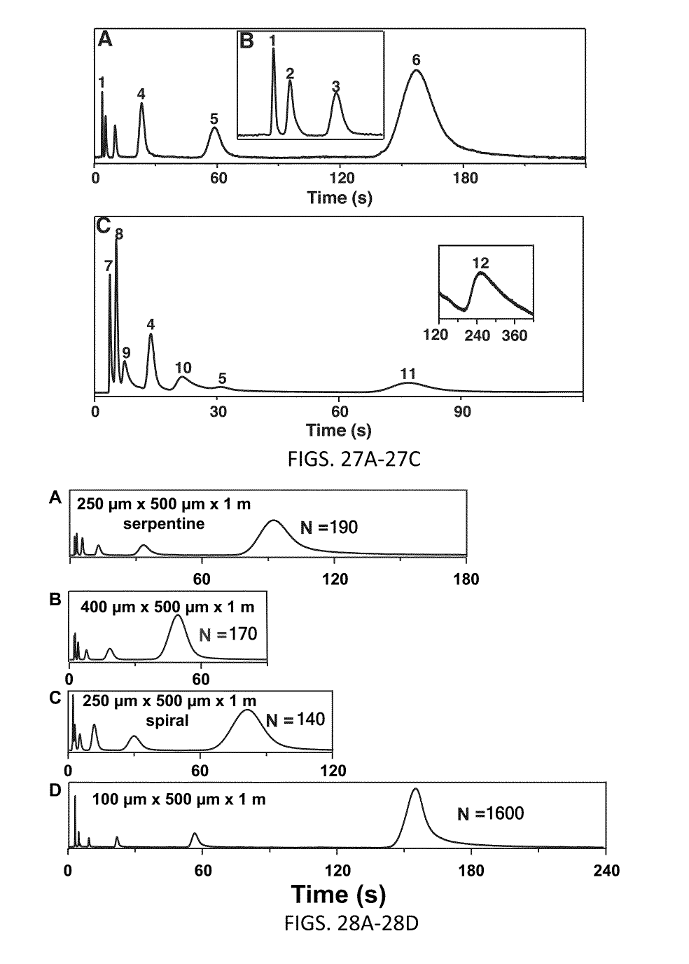

For the previously described microcolumn (a 250 μm×450 μm×1 m DP-190 10 wt. % OS#7 microcolumn) a mixture of C₅-C₁₀ n-alkanes is easily separated in less than 180 seconds at room temperature, showing six well-resolved peaks with baseline or near baseline resolution for all analytes (FIGS. 27A-27B). The peak capacity, defined as the number of equally well-resolved (Rₛ=1.0) peaks that can fit in a chromatogram between two defined retention times, is 22 between C₁ and C₁₀. All peak shapes are adequate (T_{f}<2 for commercial applications) with a T_{f}=1.45 for even the worst tailing alkane (decane), and the effective theoretical plate count is >400. Furthermore, a mixture of eight VOCs was successfully separated, extending the utility of the microcolumn beyond alkanes (FIG. 27C). This separation was achieved at 35° C. without temperature programming. Even higher boiling point analytes like nonanal (b.p. 195° C.) are detectable and elute from the column in a relatively short time span (<5 minutes).

For a given stationary phase and film thickness (or in this case, a given polymer formulation), changing column geometry may result in changes in separation efficiency. No large difference in separation efficiency was seen comparing a 250 μm×500 μm×1 m serpentine column with a 250 μm×500 μm×1 m double spiral column (FIGS. 28A,28B). Increasing the channel width from 250 μm to 400 μm also did not have a large effect on separation efficiency (FIGS. 28A,28C). Decreasing the channel width from 250 μm to 100 μm increases the theoretical plate count dramatically from N=190 to N=1600 (FIGS. 28A,28D). This can be explained by the decrease in cross-sectional area and the switch to a high aspect ratio (≧5:1) channel, which both increase the frequency and uniformity of analyte/stationary phase interaction.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

What is claimed is:

1. A microcolumn for use in gas chromatography, the microcolumn comprising:
a self-supporting polymer body functioning as a stationary phase and a structural support, the polymer body comprising:
an enclosed channel having a length L, height h and width w extending therethrough; and
one or more channel walls surrounding the enclosed channel, the one or more channel walls being integrally formed with the polymer body.

2. The microcolumn of claim 1, wherein the polymer body and the one or more channel walls comprise a phase-separated polymer composition.

3. The microcolumn of claim 1, wherein the polymer body has a nonuniform thickness about a perimeter of the enclosed channel.

4. The microcolumn of claim 1, wherein the channel walls surrounding the enclosed channel consist of an enclosing wall and one or more supporting walls, the enclosing wall having a wall thickness less than that of each of the one or more supporting walls.

5. The microcolumn of claim 4, wherein the enclosing wall comprises a wall thickness of about 100 μm or less, and the one or more supporting walls each comprise a wall thickness of at least about 1.5 times the wall thickness of the enclosing wall.

6. The microcolumn of claim 1, wherein a transverse cross-section of the enclosed channel has a polygonal shape.

7. The microcolumn of claim 6, wherein the polygonal shape is a rectangle, the polymer body comprising four channel walls surrounding the enclosed channel.

8. The microcolumn of claim 1, wherein the enclosed channel comprises a height-to-width ratio h/w of greater than 1.5.

9. The microcolumn of claim 8, wherein the height-to-width ratio h/w is greater than 2.

10. The microcolumn of claim 1, wherein w is from about 50 microns to about 400 microns, h is from about 200 microns to about 600 microns, and L is at least about 0.25 m.

11. The microcolumn of claim 1 further comprising a coating deposited on the one or more channel walls surrounding the enclosed channel, the coating comprising a polymer having a permeability of 100 barrer or greater.

12. The microcolumn of claim 2, wherein the phase-separated polymer composition comprises:
one or more matrix regions comprising a first polymer; and
one or more domain regions comprising a second polymer, the one or more domain regions being intermixed with or adjacent to the one or more matrix regions,
wherein the first polymer has a first permeability and the second polymer has a second permeability higher than the first permeability.

13. The microcolumn of claim 12, wherein at least a portion of the one or more domain regions are in gaseous communication with the enclosed channel.

14. The microcolumn of claim 12, wherein the first polymer comprises an epoxy.

15. The microcolumn of claim 12, wherein the second polymer comprises a siloxane.

16. A stationary phase for a microcolumn used in gas chromatography, the stationary phase comprising:
a phase-separated polymer composition comprising:
one or more matrix regions comprising a first polymer; and
one or more domain regions comprising a second polymer, the one or more domain regions being intermixed with or adjacent to the one or more matrix regions,
wherein the first polymer has a first permeability and the second polymer has a second permeability higher than the first permeability.

17. The stationary phase composition of claim 16, wherein the first polymer comprises an epoxy.

18. The stationary phase composition of claim 16, wherein the second polymer comprises a siloxane.

19. The stationary phase composition of claim 16, wherein the second polymer is present in the phase-separated polymer composition at a concentration of at least about 0.5 wt. %.

20. A method of making a microcolumn for use in gas chromatography, the method comprising:
casting a polymer precursor composition in a mold comprising a negative relief of a channel having a height h, width w and length L;
curing the polymer precursor composition to form a polymer replica comprising the channel, the channel extending through the polymer replica from an inlet to an outlet;
removing the polymer replica from the mold;
contacting the polymer replica with a polymer film so as to cover the channel; and
bonding the polymer replica to the polymer film, thereby forming an enclosed channel and making a microcolumn for use in gas chromatography.

21. The method of claim 20, wherein bonding the polymer replica to the polymer film comprises pressing the polymer replica and the polymer film together and applying heat thereto.

22. The method of claim 20, further comprising inserting tubing into the inlet and the outlet of the enclosed channel for flowing gas mixtures through the microcolumn.

23. The method of claim 20, where the polymer precursor composition comprises thermosetting, thermoplastic, or photocrosslinking polymer precursors.

24. The method of claim 20, wherein casting the polymer precursor composition in the mold comprises injection molding.
